(19) United States
(12) Patent Application Publication
(10) Pub. No.: US 2009/0228862 A1
(43) Pub. Date: Sep. 10, 2009

(54) MODULARIZED INTEGRATED SOFTWARE DEVELOPMENT ENVIRONMENTS

(76) Inventors: Anders Bertelrud, Burlingame, CA (US); Genevieve Lee, San Jose, CA (US); Michael H. Rawdon, Mountain View, CA (US); Eoin MacDonell, Sunnyvale, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/398,096

(22) Filed: Mar. 4, 2009

Related U.S. Application Data
(60) Provisional application No. 61/033,744, filed on Mar. 4, 2008.

(51) Int. Cl. G06F 9/44

(52) U.S. Cl. 717/100

(57) ABSTRACT

An integrated development environment which enables a program to be built for multiple platforms. The platforms may differ from each other with respect to hardware, software, operating system or any combination thereof. The same software project is used to build the program for each platform thereby alleviating the need to modify the software project specifically for a particular platform. The environment includes modules which are used to build the program for a particular platform. The modules may contain software libraries, hardware information, or other data pertaining to a platform. The environment uses the modules to select the appropriate libraries, tools, and other build settings so that the program may be built to run natively on a particular platform. A module may contain data for more than one platform or a plurality of modules may contain the data for one platform.

The present application claims priority to U.S. Provisional Application No. 61/033,744, filed Mar. 4, 2008, and entitled PLATFORM SELECTION IN AN INTEGRATED DEVELOPMENT ENVIRONMENT.

### BACKGROUND

1. Field

Embodiments of the invention relate to integrated development environments for software development. More particularly, embodiments of the invention related to modular integrated development environments.

2. Description of the Related Technology

An integrated development environment (IDE) generally provides a set of comprehensive tools to computer programmers for software development. An IDE generally may include a source code editor, a compiler and/or interpreter, and build automation tools. Most IDEs also include a debugger. Some IDEs contain version control system and various other tools to assist in software development. Many modern IDEs also have a class browser, an object inspector, and a class hierarchy diagram, for use with object oriented software development. Many modern IDEs provide windowed graphical user interfaces.

Generally, an IDE provides software development capabilities for a specific programming language. This enables the IDE to provide a feature set which is closely coupled to the programming paradigm for the specific programming language. For example, an IDE may have build automation tools and a debugger specifically designed to work with the JAVA programming language. Recently, many IDEs have incorporated support for multiple programming languages. This allows a single IDE to be used to develop software for multiple projects spanning multiple programming languages instead of using one IDE per programming language.

IDEs provide a comprehensive tool set for software development. Using an IDE, a software developer can view and edit code, build the software program, and often test and debug their program, all within one environment. This greatly enhances a software developer's productivity and efficiency. Since all of the tools are integrated and work together smoothly, the developer no longer needs to set up multiple applications to edit, build and test the program. For example, code can be compiled while being written, providing instant feedback on syntax errors. In addition, IDEs not only provide a holistic view of the program through class browsers and class hierarchy diagrams, but they allow the developer to focus in on the finer grain details of the program, such as variable values or function calls.

Many IDEs are currently available to software developers. Some of the most commonly used IDEs include Microsoft Visual Studio, Freescale CodeWarrior, Eclipse and Apple Xcode.

### BRIEF DESCRIPTION OF THE DRAWINGS

Exemplary embodiments are explained in greater detail in the following description and are illustrated in the drawings, in which:

FIG. 1A shows a component diagram of a computer system running a integrated build environment;

FIG. 1B shows another component diagram of a computer system running a integrated build environment;

FIG. 2 shows a component diagram of an integrated development environment according to an embodiment;

FIG. 3A shows a component diagram of an integrated development environment according to another embodiment;

FIG. 3B shows a component diagram of an integrated development environment according to another embodiment;

FIG. 4 shows a block diagram of a computing system;

FIGS. 5A-5C shows screenshots of different embodiments.

FIG. 6A illustrates an example embodiment of a mobile device.

FIG. 6B illustrates an example embodiment of a configurable top-level graphical user interface of a mobile device.

FIG. 7 is a block diagram of an example implementation of a mobile device.

### DETAILED DESCRIPTION

Embodiments of the present disclosure provide for an integrated development environment that easily allows the software developer to build the same software application or project for multiple platforms without having to make modifications to the source code, or to the build settings in the environment. For example, by simply selecting the target platform, the IDE would automatically use the correct libraries, build tools and other modules need to compile the application. This allows a program to be developed for one platform, but to be ported to another platform with minimal effort from the software developer.

Embodiments may now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments. Furthermore, embodiments may include several novel features, no single one of which is solely responsible for its desirable attributes or which is essential to practicing the inventions herein described.

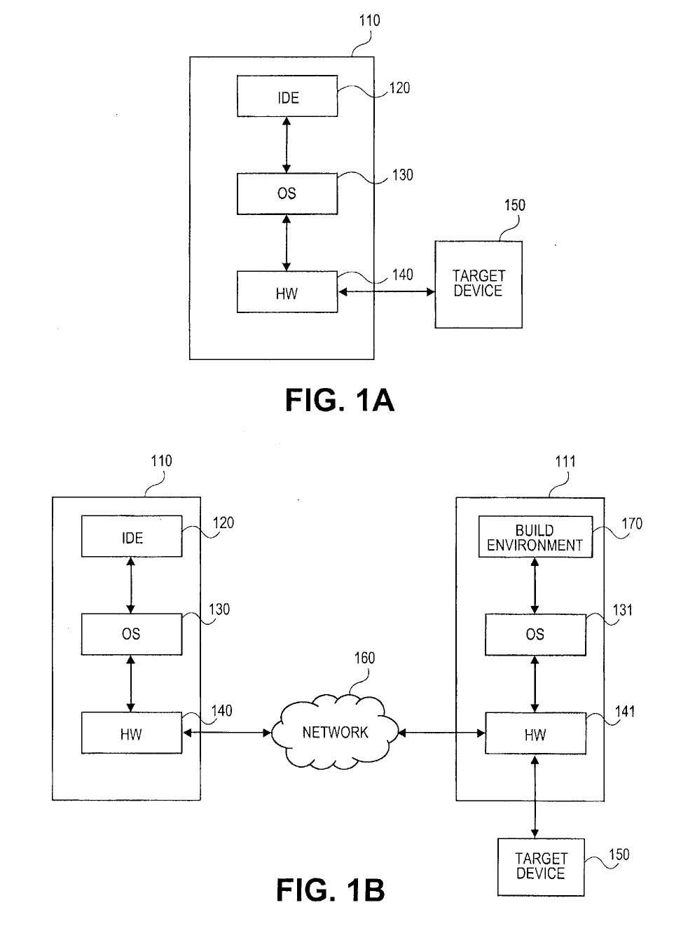

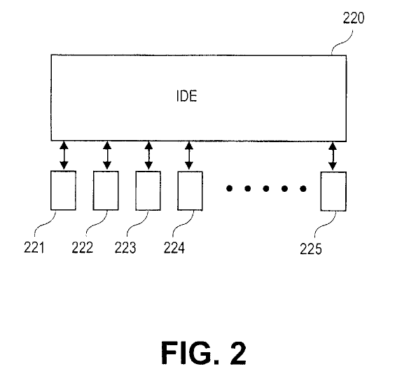

FIG. 1A shows a component diagram of computer system 110 running integrated development environment 120. The computer system 110 is an example of a computing device running a particular set of hardware 140, software and operating system 130. The IDE 120 may run within the operating system 130 and may use operating system 130 to interface with the hardware 140 of the computer system. The target device 150 is connected to the computer system 110 via the hardware 140. The connection between the target device 150 and the computer system 110 may use a wired connection including but not limited to serial cables, Ethernet cables or USB cables, or it may be a wireless connection including but not limited to WiFi connections such as IEEE 802.11b, cellular connections such as a code division multiple access (CDMA or CDMA2000) or a GSM/GPRS (General Packet Radio Service)/EDGE (enhanced data GSM environment), a Bluetooth connection or an infrared connection. The IDE 120 is used to design and build a program that may be loaded onto the target device 150. The IDE communicates with the operating system 130 which in turn interfaces with the hardware 140 which allows a program to be loaded onto target device 150.

FIG. 1B shows a component diagram of another computer system 110 running integrated development environment 120. The IDE 120 may run within the operating system 130 and may use operating system 130 to interface with the hardware 140 of the computer system. Computer system 110 is connected to a network “cloud” 160, which may represent a local area network (LAN), a wide area network (WAN), the Internet, or another connection service. A second computer system 111 is also connected to the network “cloud” 160. The second computer system 111 has a build environment 170. The build environment 170 provides the capability to build a software program. In some embodiments, the build environment 170 may be another integrated development environment running within operating system 131. In another embodiment, the build environment 170 is the minimum software needed to compile a program. The build environment 170 communicates with the operating system 131 which in turn communicates with the hardware 141. The target device 150 is connected to the computer system 111 via the hardware 141. The connection between the target device 150 and the computer system 111 may use a wired connection including but not limited to serial cables, Ethernet cables or USB cables, or it may be a wireless connection including but not limited to WiFi connections such as IEEE 802.11b, cellular connections such as a code division multiple access (CDMA or CDMA2000) or a GSM/GPRS (General Packet Radio Service)/EDGE (enhanced data GSM environment), a Bluetooth connection or an infrared connection.

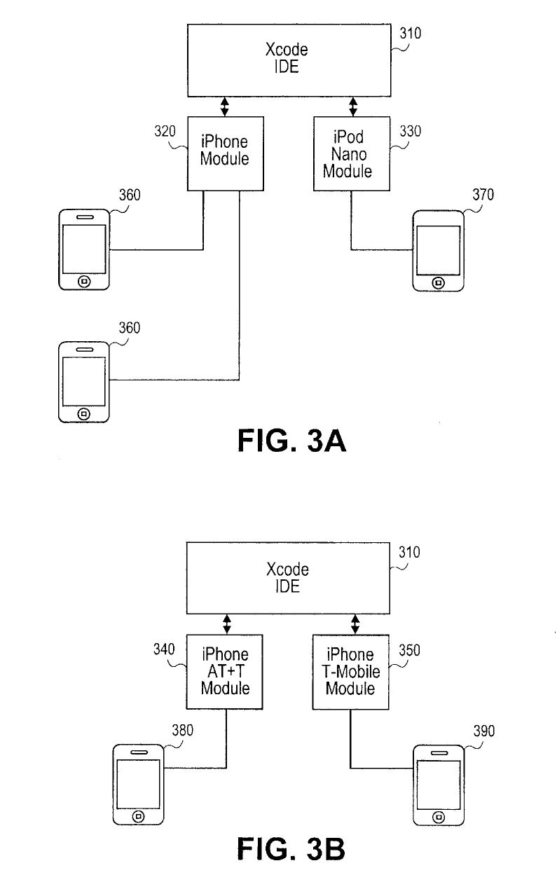

In FIG. 1B, the IDE 120 running on computer system 110 is used to create a program intended to run on target device 150. The program is not built on computer system 110. Computer system 111 builds the program using the build environment 170. Any data that is needed by build environment 170 to build the program is transmitted to build environment 170 via the network “cloud” 160 from computer system 110. After build environment 170 has built the program, the program is loaded onto the target device 150 via the hardware 141. The embodiment shown in FIG. 2 provides a useful benefit to software development. The software developer may now use an integrated development environment to write code for a program and to debug the program. The developer may then choose to build the program on another machine such as a lab machine where the target device is connected. This allows a device to be tested at a different geographic location than where the program is developed. It may also speed up the process to build the program as any available computer system may be used to build the program, rather than waiting for the current computer system to finish any pending builds.

FIG. 2 shows a component diagram according to an embodiment. In this embodiment, the Xcode IDE, from Apple Inc. may be used as an example. IDE 220 communicates with platform modules 221, 222, 223, 224 and 225. Each of platform modules 221, 222, 223, 224 and 225 may contain data that may be used by IDE 220 to build a program for different platforms. A platform may be any real or simulated device. For example, a platform may be a version of a device, such as a mobile phone, computer, etc., or, in order to assist a developer, a platform may also be a simulator of a device. In one embodiment, the simulator itself is considered a platform, even thought it may run on another platform. For example, a simulator for a mobile device may run on a computing system. Although the computing system is a platform, the simulator is also considered a platform in and of itself. In addition, in another embodiment, the simulator platform itself may be included with the platform module. This provides a simple solution for debugging and testing purposes, as the developer may use a platform module for a particular platform and use the simulator platform that may be included with the platform module.

A simulated platform may be a device. In other words, the architecture allows a simulated device to be used exactly as a real device for the purposes of building, testing, etc (subject of course to physical limitations, e.g. the simulated device might not have all the features of the physical device, such as an actual phone baseband etc). In one embodiment, the simulated device may be implemented as another platform alongside the platform for the physical device. In another embodiment, it may be implemented using the same platform as the physical device. This can be done differently for different platforms depending on their capabilities (e.g. an instruction-level “emulator” might build using the same tools as those used for the physical device).

For example, platform module 221 may be used to build a program for a mobile computing device or a developer's simulator for that mobile computing device. A plurality of modules may be used by IDE 220 to build a program for a particular platform. For example, platform modules 222 and 223 may be used to build a program for a mobile computing device. In addition, one platform module may be used to build a program for multiple modules. For example, platform module may be used to build a program for various computing platforms.

IDE 220 may communicate with an unlimited number of platform modules. A new platform module may be added at any time when a developer needs to build a program for a new platform. In one embodiment, adding a new platform module may be done by installing the module at a particular location on a memory storage device of a computer system. In this embodiment, IDE 220 allows a developer to change a build from one platform to another platform by simply selecting an option in a user interface menu within the IDE 220.

In this embodiment, IDE 220 contains a comprehensive set of tools that may be used to develop software on all platforms. For example, a source code editor, a default compiler, a default linker and a default debugger may be included in IDE 220. IDE 220 is configured to run on a particular platform. The platform modules 221-225 factor out the differences between the platform that IDE 220 runs on and the target platforms. For example, platform module 221 is used to build a program for an Mobile computing device platform. Xcode IDE 220 runs on a Mac platform. Platform module 221 may contain information such as libraries, headers, project templates, build tools and other data that may not be present on the Mac platform or is different from what is used on the Mac platform. A different compiler, linker or debugger may be used when building and testing a program for the iPod Touch platform when compared to building the same program for the Mac platform. In addition, the library files used by a program on the iPod Touch platform may be different than the libraries that are used on the Mac platform.

A platform module defines the characteristics for a particular platform. In one embodiment, a platform module may include one or more property lists. A property list may be a data driven text based file which provides information to an IDE for a particular platform. In another embodiment, the property list may not be in a text-based format. In one embodiment, the platform module is created by the developer of the IDE. In another embodiment, a platform module is created by a third party developer.

In one embodiment, the property list may contain predefined macros. A predefined macro may include a well-defined name and an optional default value. In some embodiments, a predefined macro may be given an identification such that the identification conveys the concept that the predefined macro embodies. For example, a predefined macro may be identified with the name “microprocessor” and the optional default value may be “Intel x86.” The “microprocessor” macro may provide information to the IDE regarding what type of processor the program may run on. In another example, a predefined macro may be identified with the name “optimization” and the default value may be “None.” The “optimization” macro may provide information to the IDE regarding whether or not the compiler should attempt to optimize the generated code. In another example, a predefined macro may be indentified with the name “tool chain.” The “tool chain” macro may provide information regarding the path of a build tool to invoke, provide command line options for the build tool, cause other environment variables to be set or the macro may be used to modify the context in which the tool is invoked.

In one embodiment, the IDE may provide a default value for each well-defined name. A platform module may in turn, override the default value with a value that is specific to a particular platform. In another embodiment, the platform may provide new predefined macros that are not provided by the IDE. These new macros may further define aspects or setting for a particular platform that the IDE may use when building a program for the platform. A developer may also define their own new predefined macros. A developer may choose any name for a predefined macro. Developers may or may not choose a name that conveys the concept or purpose of the macro. In another embodiment, the IDE may provide a list of predefined macros that are included by default with the IDE and the concepts or purposes of the macros. Thus, the names of predefined macros included with the IDE are “well-defined.” In one embodiment, the platform module may provide a list of the predefined macros included in the module. In another embodiment, the developer may generate documentation which provides a list of new predefined macros defined by the developer.

In one embodiment, a platform module may define different policies for different platforms. For example, a platform module may define a policy regarding digital signing for applications. The policy may require that all applications must be digitally signed. In another example, a platform module may define a policy regarding the strictness of compiler warnings. The policy may allow a program to be built even though warnings occur during the build process. Policies may define a variety of parameters including but not limited to behaviors, requirements or restrictions for a particular platform.

In one embodiment, a platform module may also contain provisioning information for a platform. Provisioning information may provide information regarding specific features or services provided by a device or platform. For example, mobile device may be provisioned to view streaming multimedia. In another embodiment, a platform module contains provision information pertaining to developer features for a particular device or platform. In this embodiment, a developer may develop and test software on the device only if the device has been provisioned for software development and the developer has been authorized to develop the software. A platform module may contain provisioning information including but not limited to the list of devices that have been provisioned for development and cryptographically secure certificates signifying that the developer has been authorized to develop software for the device.

In one embodiment, a platform module may also contain project templates. These templates may be basic source code and project shells that may be used to start development of an application. Project templates not only provide a starting point for developing a program for a platform, but they allow projected based multi-platform development. In one embodiment, all the platform modules may contain a general project template for a web application. This project template may be used to develop a web application that runs across multiple platforms. The web application would function in the same manner and have the same user interface regardless of the platform.

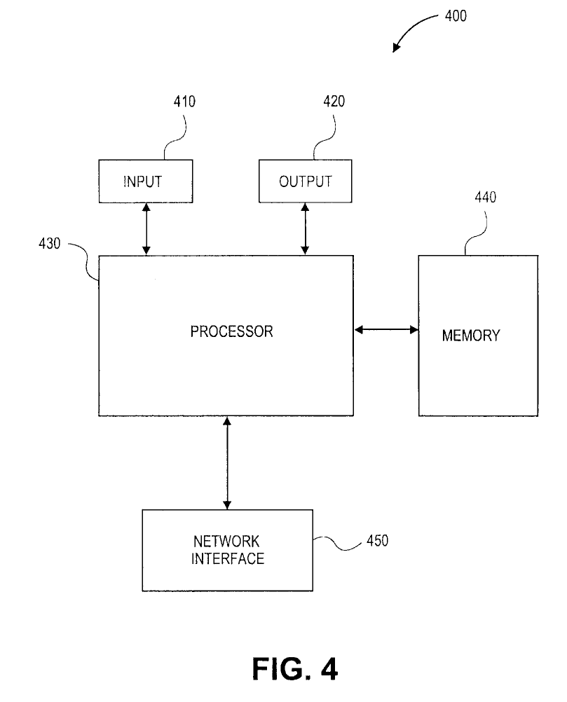

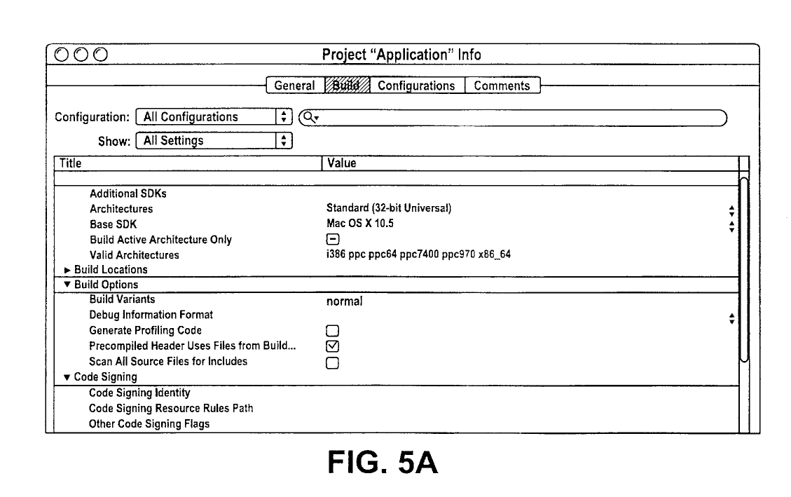

FIG. 3A shows a component diagram of an integrated development environment according to an embodiment. Xcode IDE 310 is used to develop and build a software program. Xcode IDE 310 has a platform module 320 for an iPhone and a platform module for an iPod Nano. In this example, iPhone platform and the iPod Nano platform differ from each other in terms of hardware and software. A developer may choose to develop a program that provides visual display representations of digitally formatted music being played on multimedia devices. The developer may which to develop this program for both an iPhone and an iPod Nano. The program is built to run on the iPhone platform using the iPhone platform module 320. It is then loaded onto iPhones 360. The same program may also be built to run on the iPod Touch using the iPod Touch platform module 330. The program may then be loaded onto iPod Nano 370. The software developer simply selects which platform to build the program for depending on which platform modules are installed with the Xcode IDE 310. No changes to the project, build settings or to the Xcode IDE 310 are needed in order to build the same software program for both platforms.

FIG. 3B shows a component diagram of an integrated development environment according to an embodiment. The Xcode IDE 310 is also used to develop and build a software program. Xcode IDE 310 has a platform module 340 for an iPhone provisioned for AT&T service 380 and a platform module 350 for an iPhone provisioned for T-Mobile service 390. In this example, the hardware and operating system for the two iPhones are the same. The program is built to run on iPhone 380 using the AT&T iPhone platform module 340. It is then loaded onto iPhone 380. The same program may also be built to run on iPhone 390 using the T-Mobile iPhone platform module 350. The program may then be loaded onto the iPhone 390. In this example, a developer may be authorized to develop programs that run on both an iPhone provisioned for AT&T service 380 and an iPhone provisioned for T-Mobile service 390. If the developer was not authorized to develop software tor T-Mobile, the developer would not have access to the -Mobile iPhone platform module 350. In this case, the developer would not be able to develop software for T-Mobile using the AT&T iPhone platform module 340 because the module 340 would not contain provisioning information for T-Mobile.

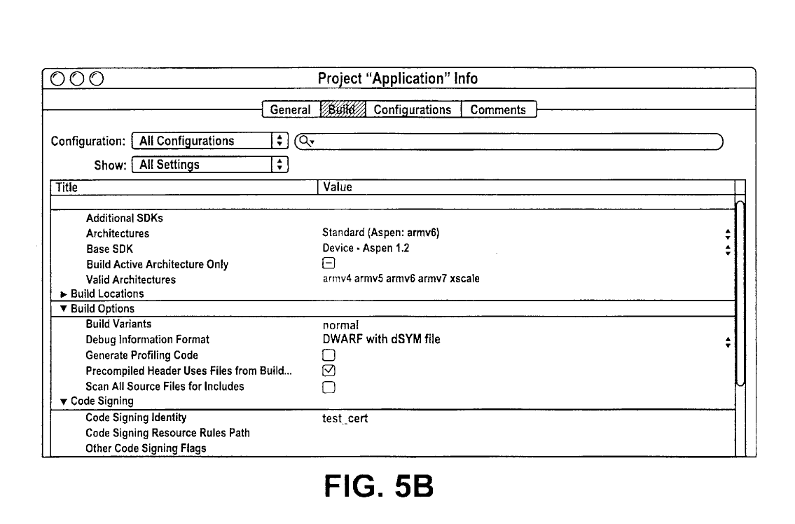

FIG. 4 is a block diagram illustrating an example of one of the computing systems 110 which may use embodiments as illustrated in FIGS. 1A and 1B. The computing system 400 includes a processor 430 that is in communication with a memory 440 and a network interface 450. The network interface 450 may receive signals according to wired technologies including but not limited to Ethernet, telephone (e.g., POTS), and fiber optic systems, and/or wireless technologies including but not limited a code division multiple access (CDMA or CDMA2000) communication system, a GSM/GPRS (General Packet Radio Service)/EDGE (enhanced data GSM environment) or an IEEE 802.11b system. The system 400 may also include one or more of an output device 420 such as a visual display and a user input device 410 such as a keypad, touch screen, or other suitable tactile input device.

Referring to FIG. 4, the computing system 400 is represented as a series of interrelated functional blocks that may represent functions implemented by, for example the processor 430, software, some combination thereof, or in some other manner as taught herein. For example, the processor 430 may facilitate user input via the input device 410.

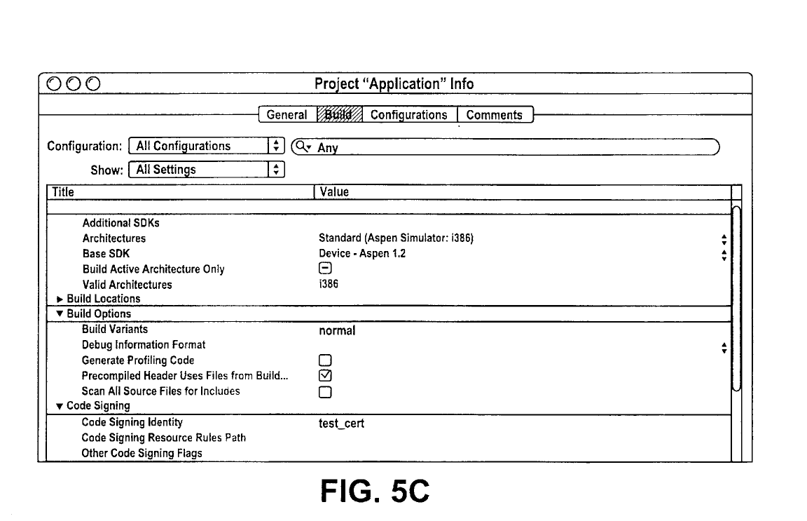

FIGS. 5A-5C are screenshots that show the user interface of an IDE according to different embodiments. In FIG. 5A, the “Mac OS X 10.5” platform has been selected and the “Architectures” and the “Build Active Architecture Only” fields have been changed to reflect the settings for the platform. The settings in FIG. 5A may indicate the application may run on “i386”, “ppc”, “ppc64” etc. platforms. Similarly, in FIG. 5B, the “Device—Aspen 1.2” platform has been selected and the “Architectures” and the “Build Active Architecture Only” fields have been changed to reflect the settings for the platform. In FIG. 5B, the settings may indicate that the application may run on the “arm” series of processors. Lastly, in FIG. 5C, the “Simulator—Aspen 1.2” platform has been selected and the “Architectures” and the “Build Active Architecture Only” fields have been changed to reflect the settings for the platform. In FIG. 5C, the build settings may indicate that the application may only run on an “i386” processor.

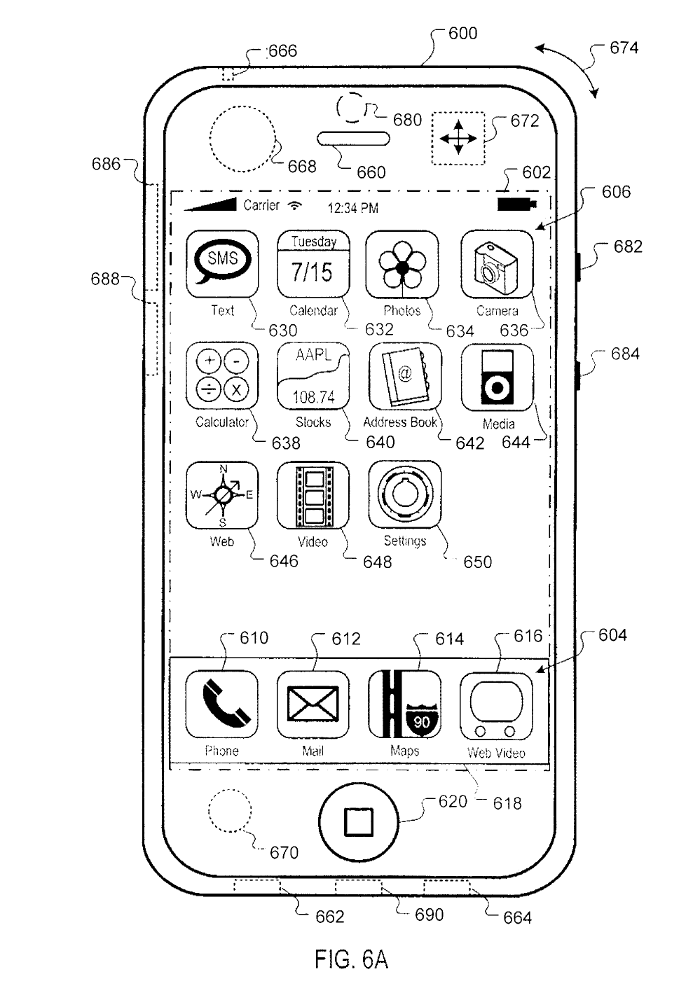

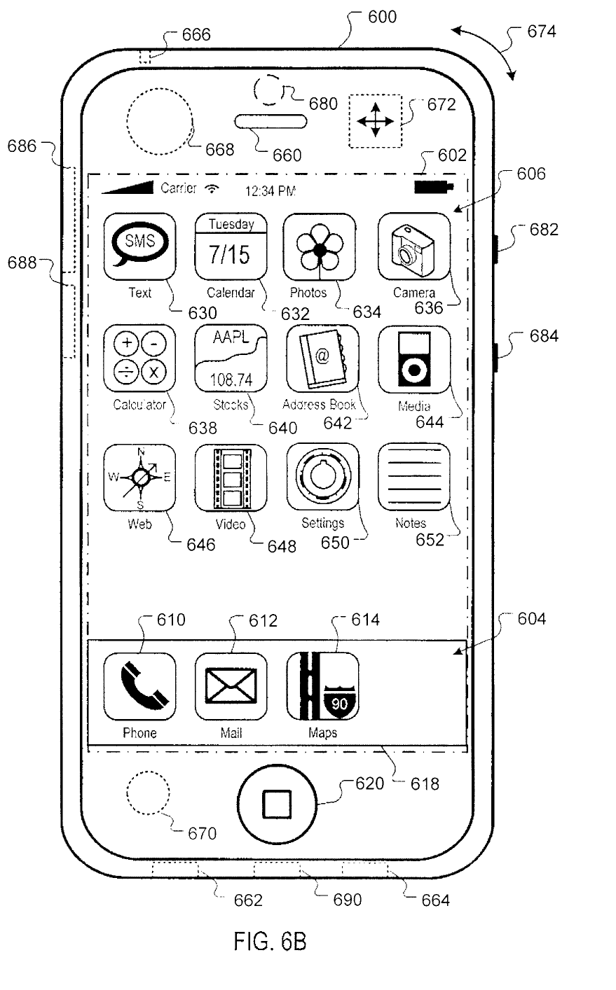

FIG. 6A illustrates an example mobile device 600. The mobile device 600 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, the mobile device 600 includes a touch-sensitive display 602. The touch-sensitive display 602 can be implemented with liquid crystal display (LCD) technology, light emitting polymer display (LPD) technology, or some other display technology. The touch-sensitive display 602 can be sensitive to haptic and/or tactile contact with a user.

In some implementations, the touch-sensitive display 602 may include a multi-touch-sensitive display 602. A multi-touch-sensitive display 602 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 600 can display one or more graphical user interfaces on the touch-sensitive display 602 for providing the user access to various system objects and for conveying information to the user. In some implementations, the graphical user interface can include one or more display objects 604, 606. In the example shown, the display objects 604, 606, are graphic representations of system objects. Some examples of system objects include device functions, applications, windows, files, alerts, events, or other identifiable system objects.

In some implementations, the mobile device 600 can implement multiple device functionalities, such as a telephony device, as indicated by a Phone object 610; an e-mail device, as indicated by the Mail object 612; a map devices, as indicated by the Maps object 614; a Wi-Fi base station device (not shown); and a network video transmission and display device, as indicated by the Web Video object 616. In some implementations, particular display objects 604, e.g., the Phone object 610, the Mail object 612, the Maps object 614, and the Web Video object 616, can be displayed in a menu bar 618. In some implementations, device functionalities can be accessed from a top-level graphical user interface, such as the graphical user interface illustrated in FIG. 5A. Touching one of the objects 610, 612, 614, or 616 can, for example, invoke a corresponding functionality.

In some implementations, the mobile device 600 can implement a network distribution functionality. For example, the functionality can enable the user to take the mobile device 600 and provide access to its associated network while traveling. In particular, the mobile device 600 can extend Internet access (e.g., Wi-Fi) to other wireless devices in the vicinity. For example, mobile device 600 can be configured as a base station for one or more devices. As such, mobile device 600 can grant or deny network access to other wireless devices.

In some implementations, upon invocation of a device functionality, the graphical user interface of the mobile device 600 changes, or is augmented or replaced with another user interface or user interface elements, to facilitate user access to particular functions associated with the corresponding device functionality. For example, in response to a user touching the Phone object 610, the graphical user interface of the touch-sensitive display 602 may present display objects related to various phone functions; likewise, touching of the Mail object 612 may cause the graphical user interface to present display objects related to various e-mail functions; touching the Maps object 614 may cause the graphical user interface to present display objects related to various maps functions; and touching the Web Video object 616 may cause the graphical user interface to present display objects related to various web video functions.

In some implementations, the top-level graphical user interface environment or state of FIG. 6A can be restored by pressing a button 620 located near the bottom of the mobile device 600. In some implementations, each corresponding device functionality may have corresponding “home” display objects displayed on the touch-sensitive display 602, and the graphical user interface environment of FIG. 6A can be restored by pressing the “home” display object.

In some implementations, the top-level graphical user interface can include additional display objects 606, such as a short messaging service (SMS) object 630, a Calendar object 632, a Photos object 634, a Camera object 636, a Calculator object 638, a Stocks object 640, a Address Book object 642, a Media object 644, a Web object 646, a Video object 648, a Settings object 650, and a Notes object (not shown). Touching the SMS display object 630 can, for example, invoke an SMS messaging environment and supporting functionality; likewise, each selection of a display object 632, 634, 636, 638, 640, 642, 644, 646, 648, and 650 can invoke a corresponding object environment and functionality.

Additional and/or different display objects can also be displayed in the graphical user interface of FIG. 6A. For example, if the device 600 is functioning as a base station for other devices, one or more “connection” objects may appear in the graphical user interface to indicate the connection. In some implementations, the display objects 606 can be configured by a user, e.g., a user may specify which display objects 606 are displayed, and/or may download additional applications or other software that provides other functionalities and corresponding display objects.

In some implementations, the mobile device 600 can include one or more input/output (I/O) devices and/or sensor devices. For example, a speaker 660 and a microphone 662 can be included to facilitate voice-enabled functionalities, such as phone and voice mail functions. In some implementations, an up/down button 684 for volume control of the speaker 660 and the microphone 662 can be included. The mobile device 600 can also include an on/off button 682 for a ring indicator of incoming phone calls. In some implementations, a loud speaker 664 can be included to facilitate hands-free voice functionalities, such as speaker phone functions. An audio jack 666 can also be included for use of headphones and/or a microphone.

In some implementations, a proximity sensor 668 can be included to facilitate the detection of the user positioning the mobile device 600 proximate to the user's ear and, in response, to disengage the touch-sensitive display 602 to prevent accidental function invocations. In some implementations, the touch-sensitive display 602 can be turned off to conserve additional power when the mobile device 600 is proximate to the user's ear.

Other sensors can also be used. For example, in some implementations, an ambient light sensor 670 can be utilized to facilitate adjusting the brightness of the touch-sensitive display 602. In some implementations, an accelerometer 672 can be utilized to detect movement of the mobile device 600, as indicated by the directional arrow 674. Accordingly, display objects and/or media can be presented according to a detected orientation, e.g., portrait or landscape. In some implementations, the mobile device 600 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 600 or provided as a separate device that can be coupled to the mobile device 600 through an interface (e.g., port device 690) to provide access to location-based services.

In some implementations, a port device 690, e.g., a Universal Serial Bus (USB) port, or a docking port, or some other wired port connection, can be included. The port device 690 can, for example, be utilized to establish a wired connection to other computing devices, such as other communication devices 600, network access devices, a personal computer, a printer, a display screen, or other processing devices capable of receiving and/or transmitting data. In some implementations, the port device 690 allows the mobile device 600 to synchronize with a host device using one or more protocols, such as, for example, the TCP/IP, HTTP, UDP and any other known protocol.

The mobile device 600 can also include a camera lens and sensor 680. In some implementations, the camera lens and sensor 680 can be located on the back surface of the mobile device 600. The camera can capture still images and/or video.

The mobile device 600 can also include one or more wireless communication subsystems, such as an 802.11b/g communication device 686, and/or a Bluetooth™ communication device 688. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

FIG. 6B illustrates another example of configurable top-level graphical user interface of device 600. The device 600 can be configured to display a different set of display objects.

In some implementations, each of one or more system objects of device 600 has a set of system object attributes associated with it; and one of the attributes determines whether a display object for the system object will be rendered in the top-level graphical user interface. This attribute can be set by the system automatically, or by a user through certain programs or system functionalities as described below. FIG. 6B shows an example of how the Notes object 652 (not shown in FIG. 6A) is added to and the Web Video object 616 is removed from the top graphical user interface of device 600 (e.g. such as when the attributes of the Notes system object and the Web Video system object are modified).

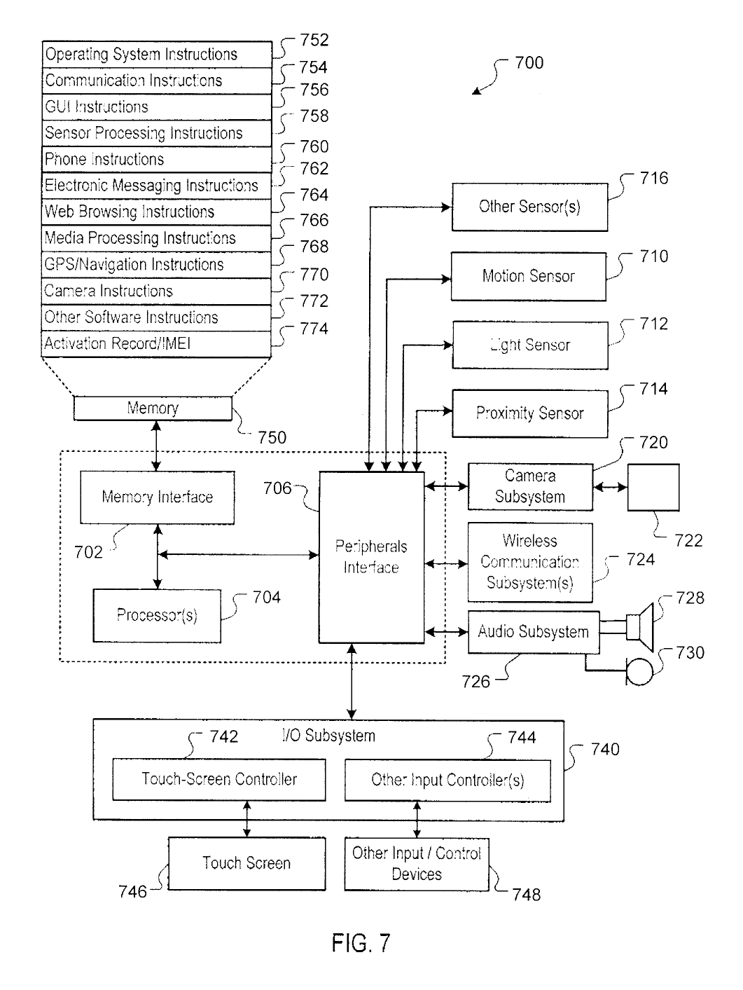

FIG. 7 is a block diagram 700 of an example implementation of a mobile device (e.g., mobile device 600). The mobile device can include a memory interface 702, one or more data processors, image processors and/or central processing units 704, and a peripherals interface 706. The memory interface 702, the one or more processors 704 and/or the peripherals interface 706 can be separate components or can be integrated in one or more integrated circuits. The various components in the mobile device can be coupled by one or more communication buses or signal lines.

Sensors, devices, and subsystems can be coupled to the peripherals interface 706 to facilitate multiple functionalities. For example, a motion sensor 710, a light sensor 712, and a proximity sensor 714 can be coupled to the peripherals interface 706 to facilitate the orientation, lighting, and proximity functions described with respect to FIG. 6A. Other sensors 716 can also be connected to the peripherals interface 706, such as a positioning system (e.g., GPS receiver), a temperature sensor, a biometric sensor, or other sensing device, to facilitate related functionalities.

A camera subsystem 720 and an optical sensor 722, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 724, which can include radio frequency receivers and transmitters and/or optical (e.g., infrared) receivers and transmitters. The specific design and implementation of the communication subsystem 724 can depend on the communication network(s) over which the mobile device is intended to operate. For example, a mobile device can include communication subsystems 724 designed to operate over a GSM network, a GPRS network, an EDGE network, a Wi-Fi or WiMax network, and a Bluetooth™ network. In particular, the wireless communication subsystems 724 may include hosting protocols such that the mobile device may be configured as a base station for other wireless devices.

An audio subsystem 726 can be coupled to a speaker 728 and a microphone 730 to facilitate voice-enabled functions, such as voice recognition, voice replication, digital recording, and telephony functions.

The I/O subsystem 740 can include a touch screen controller 742 and/or other input controller(s) 744. The touch-screen controller 742 can be coupled to a touch screen 746. The touch screen 746 and touch screen controller 742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 746.

The other input controller(s) 744 can be coupled to other input/control devices 748, such as one or more buttons, rocker switches, thumb-wheel, infrared port, USB port, and/or a pointer device such as a stylus. The one or more buttons (not shown) can include an up/down button for volume control of the speaker 728 and/or the microphone 730.

In one implementation, a pressing of the button for a first duration may disengage a lock of the touch screen 746; and a pressing of the button for a second duration that is longer than the first duration may turn power to the mobile device on or off. The user may be able to customize a functionality of one or more of the buttons. The touch screen 746 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

The memory interface 702 can be coupled to memory 750. The memory 750 can include high-speed random access memory and/or non-volatile memory, such as one or more magnetic disk storage devices, one or more optical storage devices, and/or flash memory (e.g., NAND, NOR). The memory 750 can store an operating system 752, such as Darwin, RTXC, LINUX, UNIX, OS X, WINDOWS, or an embedded operating system such as VxWorks. The operating system 752 may include instructions for handling basic system services and for performing hardware dependent tasks. In some implementations, the operating system 752 can be a kernel (e.g., UNIX kernel).

The memory 750 may also store communication instructions 754 to facilitate communicating with one or more additional devices, one or more computers and/or one or more servers. The memory 750 may include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes and instructions; camera instructions 770 to facilitate camera-related processes and functions; and/or other software instructions 772 to facilitate other processes and functions, e.g., access control management functions. The memory 750 may also store other software instructions (not shown), such as web video instructions to facilitate web video-related processes and functions; and/or web shopping instructions to facilitate web shopping-related processes and functions. In some implementations, the media processing instructions 766 are divided into audio processing instructions and video processing instructions to facilitate audio processing-related processes and functions and video processing-related processes and functions, respectively. An activation record and International Mobile Equipment Identity (IMEI) 774 or similar hardware identifier can also be stored in memory 750.

The system may include various modules, tools, and applications as discussed in detail above. As can be appreciated by one of ordinary skill in the art, each of the modules may include various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system modules, tools, and applications may be written in any programming language such as, for example, C, C++, BASIC, Visual Basic, Pascal, Ada, Java, HTML, XML, or FORTRAN, and executed on an operating system, such as variants of Windows, Macintosh, UNIX, Linux, VxWorks, or other operating system. C, C++, BASIC, Visual Basic, Pascal, Ada, Java, HTML, XML and FORTRAN are industry standard programming languages for which many commercial compilers can be used to create executable code.

The above-described method may be realized in a program format to be stored on a computer readable recording medium that includes any kinds of recording devices for storing computer readable data, for example, a CD-ROM, a DVD, a magnetic tape, memory card, and a disk, and may also be realized in a carrier wave format (e.g., Internet transmission or Bluetooth transmission).

While specific blocks, sections, devices, functions and modules may have been set forth above, a skilled technologist may realize that there are many ways to partition the system, and that there are many parts, components, modules or functions that may be substituted for those listed above.

While the above detailed description has shown, described, and pointed out the fundamental novel features as applied to various embodiments, it may be understood that various omissions and substitutions and changes in the form and details of the system illustrated may be made by those skilled in the art, without departing from the intent of the invention.

What is claimed is:

1. An integrated development environment running on a host computing device comprising:
a generic integrated development core that provides platform-independent development tools;
a first platform module to factor out differences between the host computing device and a first target platform, wherein the first platform module contain data to be used by the integrated development environment on the host computing device to develop applications for the first target platform;
the integrated development environment to use the generic integrated development core and the first platform module together to build an application to run natively on the first target platform.

2. The integrated development environment of claim 1 wherein the host computing device and the first target platform have different operating systems.

3. The integrated development environment of claim 1 wherein the generic integrated development core comprises a source code editor, a default compiler, a default linker and a default debugger.

4. The integrated development environment of claim 1 wherein the first platform module comprises one or more libraries specific to the first target platform.

5. The integrated development environment of claim 1 wherein the first platform module comprises a first target platform dependent compiler and a first target platform dependant linker.

6. The integrated development environment of claim 1 wherein the first platform module comprises a first platform simulator corresponding to the first target platform.

7. The integrated development environment of claim 1, wherein a source code is built by the generic integrated development core as an application for the host computing device and built by the generic integrated development core and the first platform module as an application for the first target platform.

8. The integrated development environment of claim 1 further comprising a second platform module to factor out differences between the host computing device and a second target platform, wherein the second platform module contains data to be used by the integrated development environment on the host computing device to develop applications for the second target platform, the integrated development environment to use the generic integrated development core and the second platform module together to build an application to run natively on the second target platform.

9. The integrated development environment of claim 8 wherein the second target platform, the first target platform and the host computing device each have different operating systems.

10. The integrated development environment of claim 8 wherein the second platform module comprises one or more libraries specific to the second target platform.

11. The integrated development environment of claim 10 wherein the second platform module comprises a second target platform dependent compiler and a second target platform dependant linker.

12. The integrated development environment of claim 9 wherein the second platform module comprises a second platform simulator corresponding to the second target platform.

13. A method for developing an application for a target electronic platform with an integrated development environment on a host electronic platform, the method comprising:
evaluating a source code in a generic integrated development core that provides-platform independent development tools on a host electronic platform;
determining if the source code is destined for the host electronic platform or for a first target electronic platform;
compiling the source code using the generic integrated development cored for the host electronic platform if the source code is destined for the host electronic platform;
compiling the source code using a first platform module having data to be used by the integrated development environment on the host computing device to develop applications for the first target platform.

14. The method of claim 13 further comprising transmitting the complied source code as an application to the first target platform.

15. The method of claim 13 wherein the application for the host computing device functions with a first operating system and the application for the first target platform functions with a second operating system.

16. The method of claim 13 wherein the generic integrated development core comprises a source code editor, a default compiler, a default linker and a default debugger.

17. The method of claim 13 wherein the first platform module comprises one or more libraries specific to the first target platform.

18. The method of claim 13 wherein the first platform module comprises a first target platform dependent compiler and a first target platform dependant linker.

19. The method of claim 13 wherein the first platform module comprises a first platform simulator corresponding to the first target platform.

20. An article of manufacture comprising a computer-readable medium having instructions stored thereon that, when executed, cause one or more processors to provide an integrated development environment for developing an application for a target electronic platform on a host electronic platform by:
evaluating a source code in a generic integrated development core that provides-platform independent development tools on a host electronic platform;
determining if the source code is destined for the host electronic platform or for a first target electronic platform;
compiling the source code using the generic integrated development cored for the host electronic platform if the source code is destined for the host electronic platform;
compiling the source code using a first platform module having data to be used by the integrated development environment on the host computing device to develop applications for the first target platform.

21. The article of claim 20 further comprising instructions that, when executed, cause the one or more processors to transmit the complied source code as an application to the first target platform.

22. The article of claim 20 wherein the application for the host computing device functions with a first operating system and the application for the first target platform functions with a second operating system.

23. The article of claim 20 wherein the generic integrated development core comprises a source code editor, a default compiler, a default linker and a default debugger.

24. The article of claim 20 wherein the first platform module comprises one or more libraries specific to the first target platform.

25. The article of claim 20 wherein the first platform module comprises a first target platform dependent compiler and a first target platform dependant linker.

26. The article of claim 20 wherein the first platform module comprises a first platform simulator corresponding to the first target platform.
